(19) United States
(12) Patent Application Publication
(10) Pub. No.: US 2024/0337959 A1
(43) Pub. Date: Oct. 10, 2024

(54) METHOD FOR PRODUCING ELECTROSTATIC CHARGE IMAGE DEVELOPING TONER

(71) Applicant: Konica Minolta, Inc., Tokyo (JP)

(72) Inventors: Junya ONISHI, Tokyo (JP); Yusuke TAKIGAURA, Tokyo (JP); Yukiko NAKAI, Kawasaki-shi (JP); Michiaki ISHIKAWA, Sagamihara-shi (JP); Keiji ARAI, Tokyo (JP)

(21) Appl. No.: 18/622,708

(22) Filed: Mar. 29, 2024

(30) Foreign Application Priority Data
Apr. 4, 2023 (JP) 2023-060792

(51) Int. Cl. G03G 9/08; G03G 9/087

(52) U.S. Cl. CPC G03G 9/0815; G03G 9/0823; G03G 9/08755

(57) ABSTRACT

Disclosed is a method for producing an electrostatic charge image developing toner, including: drying wet toner base particles to produce the electrostatic charge image developing toner. The toner base particles contain an amorphous polyester that is a polycondensate of a polyvalent carboxylic acid and a polyhydric alcohol. In the amorphous polyester, a content of a structural unit derived from bisphenol A or a bisphenol A derivative is 10 mol % or less with respect to total moles of a structural unit derived from the polyhydric alcohol. The drying comprises drying the wet toner base particles with an airflow in a dryer. A temperature of the airflow is equal to or higher than 60° C. A velocity of the airflow is greater than or equal to 5 m/sec.

### CROSS REFERENCE TO RELATED APPLICATIONS

The entire disclosure of Japanese Patent Application No. 2023-060792, filed on Apr. 4, 2023, including description, claims, drawings and abstract is incorporated herein by reference in its entirety.

### BACKGROUND OF THE INVENTION

### Technical Field

The present invention relates to a method for producing a toner for developing an electrostatic charge image. More specifically, the present invention relates to a method for producing an electrostatic charge image developing toner that reduces unevenness in the density of an image to be formed.

### Description of Related Art

With the spread of copying machines and printers, higher performance is required for electrostatic charge image developing toners to be used for image formation. In recent years, a digital printing technology called print-on-demand (POD) in which printing is directly performed without a plate-making process has attracted attention. Since POD can cope with small-lot printing and variable printing in which print contents are changed for each sheet, POD is excellent in usability as compared with conventional offset printing. In addition, in the printing technology, there are increasing demands for higher-speed printing and energy saving.

Hereinafter, the electrostatic charge image developing toner is also simply referred to as a “toner”.

Japanese Unexamined Patent Publication No. 2016-66018 discloses a toner in which the ratio of a crystalline polyester contained in toner base particles and the storage modulus of the toner fall within specific ranges. Further, Japanese Unexamined Patent Publication No. 2017-062344 discloses a technique for a toner in which toner base particles contain a specific kind of polyester.

These toners are high-performance toners from the viewpoint of energy saving and the like, but suffer from a problem of unevenness in the density, which is likely to occur in an image to be formed.

### SUMMARY OF THE INVENTION

The present invention has been made in consideration of the above-described problem and situation, and an object to be solved by the present invention is to provide a method for producing a toner for electrostatic charge image development that reduces density unevenness of an image to be formed.

In order to solve the above-mentioned problems, the present inventors have studied the causes of the above-mentioned problems and, as a result, have found the following technique and have completed the present invention. In the method for manufacturing the electrostatic charge image developing toner by drying wet toner base particles, the toner base particles have a specific constitution, and the method includes a step of drying the wet toner base particles by an airflow in a dryer at a specific temperature and a speed of the airflow. This can reduce unevenness in the density of an image to be formed using the electrostatic charge image developing toner.

That is, the above problems relating to the present invention are solved by the following method reflecting one aspect of the present invention for producing an electrostatic charge image developing toner.

A method for producing an electrostatic charge image developing toner, that includes drying wet toner base particles to produce the electrostatic charge image developing toner, wherein
the toner base particles contain an amorphous polyester that is a polycondensate of a polyvalent carboxylic acid and a polyhydric alcohol,
in the amorphous polyester, a content of a structural unit derived from bisphenol A or a bisphenol A derivative is 10 mol % or less with respect to total moles of a structural unit derived from the polyhydric alcohol,
the drying comprises drying the wet toner base particles with an airflow in a dryer,
a temperature of the airflow is equal to or higher than 60° C., and
a velocity of the airflow is greater than or equal to 5 m/sec.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is an explanatory diagram illustrating an example of a flash dryer;

FIG. 2 is an explanatory diagram illustrating an example of a plant for performing continuous drying treatment;

FIG. 3 is a schematic cross-sectional view illustrating an example configuration of the image forming apparatus; and

FIG. 4 is a schematic diagram illustrating measurement points for reflection density in the evaluation of image unevenness.

### DETAILED DESCRIPTION

Hereinafter, an embodiment of the method for manufacturing an electrostatic charge image developing toner of the present invention will be described with reference to the accompanying drawings. However, the scope of the invention is not limited to the disclosed embodiments.

The method for producing an electrostatic charge image developing toner of the present embodiment is a method for producing an electrostatic charge image developing toner in which wet toner base particles are dried to produce an electrostatic charge image developing toner. The toner base particles contain amorphous polyester that is a polycondensate of polyvalent carboxylic acid and polyhydric alcohol. In the amorphous polyester, the content of the structural units derived from bisphenol A or a bisphenol A derivative is 10 mol % or less with respect to the total moles of the structural units derived from the polyhydric alcohol. The method for producing an electrostatic charge image developing toner includes a step of drying the wet toner base particles with airflow in a dryer. The temperature of the airflow is 60° C. or more, and the velocity of the airflow is 5 m/sec or more.

This feature is a technical feature common to or corresponding to the following embodiments.

In an embodiment of the present invention, it is preferable that the amorphous polyester does not have the structural unit derived from bisphenol A or a bisphenol A derivative as the structural unit derived from the polyhydric alcohol from the viewpoint of charge retaining performance.

In an embodiment of the present invention, the polyhydric alcohol is preferably an aliphatic polyhydric alcohol having 5 to 7 carbon atoms from the viewpoint of charge retaining performance.

In an embodiment of the present invention, the content of the amorphous polyester is preferably 20% by mass or more with respect to the total mass of the toner base particles from the viewpoint of low-temperature fixability.

In an embodiment of the present invention, the amorphous polyester preferably has a glass transition temperature in the range of 30 to 70° C. from the viewpoint of achieving both low-temperature fixability and heat-resistant storage property.

In an embodiment of the present invention, the glass transition temperature of the electrostatic charge image developing toner is preferably in a range of 15 to 40° C. from the viewpoint of achieving both low-temperature fixability and heat-resistant storage property.

In an embodiment of the present invention, the toner base particles preferably contain a crystalline polyester from the viewpoint of low-temperature fixability. The crystalline polyester preferably has a melting point of 75° C. or lower.

In an embodiment of the present invention, the crystalline polyester preferably has a structural unit derived from an aliphatic diol and a structural unit derived from an aliphatic carboxylic acid, from the viewpoint of achieving both low-temperature fixability and charge retaining performance. Furthermore, it is preferable that the aliphatic diol or the aliphatic carboxylic acid has 6 to 10 carbon atoms.

In an embodiment of the present invention, it is preferable that the toner base particles contain a release agent, and a melting point of the release agent is in a range of 60 to 80° C., from the viewpoint of separability during fixation of the toner.

In an embodiment of the present invention, the toner base particles preferably have a core-shell structure from the viewpoint of achieving both low-temperature fixability and heat-resistant storage property.

In an embodiment of the present invention, the velocity of the airflow is preferably in a range of 8 to 20 m/sec from the viewpoint of charge retention performance.

In an embodiment of the present invention, the content of a solvent in the wet toner base particles is preferably in a range of 15 to 30% by mass from the viewpoint of charge retaining performance.

In an embodiment of the present invention, it is preferable to further include desolvating the wet toner base particles before the drying, from the viewpoint of charge retaining performance.

Hereinafter, the present invention, constituent elements thereof, and modes and aspects for carrying out the present invention will be described in detail. In the present description, when two numbers are used to indicate a range of value before and after “to”, these numbers are included in the range as the lower limit value and the upper limit value.

According to the present embodiment, it is possible to provide a method for manufacturing an electrostatic charge image developing toner that suppresses unevenness in density of an image to be formed.

The expression mechanism or action mechanism of the present embodiment has not been revealed yet, but it is presumed as follows.

Unevenness in density of an image formed by a toner is caused by low charge retention performance of the toner. Specifically, if the charge of the charged toner is likely to leak, the toner cannot retain a desired charge and the toner cannot adhere to a desired position on the recording medium. As a result, unevenness occurs in the density of the image.

In a method of producing a toner by drying wet toner base particles, even when sufficient drying is performed, a solvent such as water remains in the toner base particles. It has been found that the ease of charge leakage is affected by the amount of the residual solvent and the state of the solvent present in the toner base particles.

In the toner produced by the production method of the present invention, the toner base particles contain an amorphous polyester which is a polycondensate of a polyvalent carboxylic acid and a polyhydric alcohol. The content of the structural unit derived from bisphenol A or a bisphenol A derivative is 10 mol % or less with respect to the total moles of the structural unit derived from the polyhydric alcohol in the amorphous polyester.

As described above, when the binder resin of the toner base particles has a specific structure, the inter-bond distance of the ester bond in the binder resin is easily made uniform, and a portion where the ester group is locally present at a high density is hardly formed. Specifically, it is assumed that a hydrophilic moiety derived from an ester bond and a hydrophobic moiety derived from a hydrocarbon group are appropriately dispersed, and thus, charge leakage can be suppressed.

Further, the method for producing a toner of the present invention includes drying the wet toner base particles by an airflow in a dryer. The temperature of the airflow is 60° C. or more, and the velocity of the airflow is 5 m/sec or more.

It is assumed that such rapid drying of the toner base particles at a relatively high temperature allows for uniform state the solvent present in the toner base particles. Specifically, it is assumed that the solvent adsorbed on the outermost layer of the toner base particles can be sufficiently removed, and the solvent in the toner base particles can be uniformly dispersed.

### 1. Summary of Present Invention

The method for producing an electrostatic charge image developing toner of the present invention is a method for producing an electrostatic charge image developing toner by drying wet toner base particles. The toner base particles contain amorphous polyester that is a polycondensate of a polyvalent carboxylic acid and a polyhydric alcohol. In the amorphous polyester, the content of the structural units derived from bisphenol A or a bisphenol A derivative is 10 mol % or less with respect to the total moles of the structural units derived from the polyhydric alcohol. The method for producing an electrostatic charge image developing toner includes drying the wet toner base particles with airflow in a dryer. The temperature of the airflow is 60° C. or more, and the velocity of the airflow is 5 m/sec or more.

That is, the toner base particles have a specific configuration. The wet toner base particles are dried under specific conditions. This enables obtainment of a toner having excellent charge retention performance and reduction of unevenness in density of an image to be formed.

Hereinafter, the configuration of the electrostatic charge image developing toner, the physical properties of the electrostatic charge image developing toner, the structure of the electrostatic charge image developing toner, the developer, the method for producing the electrostatic charge image developing toner, the image forming method, and the image forming apparatus will be described in this order.

### 2. Configuration of Electrostatic Charge Image Developing Toner

In the present specification, the electrostatic charge image developing toner is also simply referred to as a “toner”. The toner includes toner base particles. An external additive is preferably attached to the surfaces of the toner base particles.

The term “toner base particles” refers to particles that form the base of “toner particles”. When an external additive is added to the “toner base particle”, the resultant is referred to as a “toner particle”. The term “toner” refers to an aggregate of toner particles.

### (1) Components of Toner Base Particle

The “toner base particles” according to the present invention preferably contain constituent components such as a binder resin, a colorant, a wax, and a charge control agent, if necessary.

Hereinafter, the binder resin, the release agent, the colorant, and the charge control agent will be described.

### (1.1) Binder Resin

Since the toner base particles contain a binder resin, the toner can be fixed onto a recording medium.

The binder resin according to the present invention contains an amorphous polyester that is a polycondensate of a polyvalent carboxylic acid and a polyhydric alcohol. If necessary, another amorphous resin in addition to the amorphous polyester and a crystalline resin may be contained.

### (Analysis Method of Resin Composition)

The composition of each resin contained in the toner base particles can be analyzed by, for example, pyrolysis gas chromatography/mass spectrometry (GC/MS).

Specifically, the amount can be determined by the standard addition method using a column and a detector that have been confirmed to be able to detect a monomer having a specific structure.

An example of detailed thermal decomposition conditions and GC/MS measurement conditions is given below.

### (Pyrolysis Conditions)

Measurement device: PY 2020iD (manufactured by Frontier Laboratories Ltd.)
Weight of measurement: 0.1 mg
Heating temperature: 550° C.
Heating time: 0.5 minutes

### (Measurement Conditions of GC/MS)

Measuring device: QP2010 (manufactured by Shimadzu Corporation)
Column: UltraALLOY-5 (inside diameter: 0.25 mm, length: 30 m, thickness: 0.25 μm, manufactured by
Frontier Laboratories Ltd.)
Temperature increase range: 40° C. to 320° C. (held at 320° C.)
Temperature increase rate: 20° C./min

### (1.1.1) Amorphous Resin

In the present invention, the term “exhibiting amorphousness” means that the resin has a glass transition temperature (Tg) but does not have a melting point, that is, a clear endothermic peak during temperature increase in an endothermic curve obtained by differential scanning calorimetry (DSC). The clear endothermic peak refers to an endothermic peak having a half width of 15° C. or less in an endothermic curve when the temperature is increased at a temperature increase rate of 10° C./min.

### (1.1.1.1) Amorphous Polyester

From the viewpoint of low-temperature fixability, the toner according to the present invention contains an amorphous polyester.

The “amorphous polyester” refers to a polyester that exhibits amorphousness among polyesters obtained by a polycondensation reaction of a divalent or higher-valent carboxylic acid (polycarboxylic acid) monomer and a divalent or higher-valent alcohol (polyhydric alcohol) monomer. The amorphous polyester can be synthesized by polycondensation (esterification) of the aforementioned polyvalent carboxylic acid monomer and polyhydric alcohol monomer using a known esterification catalyst.

The polyvalent carboxylic acid is a compound containing two or more carboxy groups in one molecule.

Examples of the polyvalent carboxylic acids include phthalic acid; isophthalic acid; terephthalic acid; trimellitic acid; naphthalene-2,6-dicarboxylic acids; malonic acid; mesaconic acid; dimethyl isophthalate; fumaric acid; dodecenyl succinic acid and 1,10-dodecanedicarboxylic acid. Among these, dimethyl isophthalate, terephthalic acid, dodecenylsuccinic acid, and trimellitic acid are preferable.

These may be contained alone or in combination of two or more.

The polyhydric alcohol is a compound having two or more hydroxy groups in one molecule.

Examples of the polyhydric alcohol include ethylene glycol, propylene glycol, butanediol, diethylene glycol, pentanediol, neopentyl glycol, hexanediol, heptanediol, cyclohexanediol, octanediol, decanediol, dihydric alcohols such as dodecanediol; tri- or more valent polyols such as glycerin, pentaerythritol, hexamethylol melamine, hexaethylolmelamine, tetramethylolbenzoguanamine, tetraethylolbenzoguanamine; and the ester compounds thereof; hydroxycarboxylic acid derivatives; and the like.

These may be contained alone or in combination of two or more.

Note that the bisphenols can be esterified similarly to the alcohols. Therefore, in the present invention, the above-described “polyhydric alcohol” includes bisphenol A or bisphenol A derivatives. Examples of bisphenol A derivatives include an ethylene oxide adduct of bisphenol A (BPA-EO) and a propylene oxide adduct of bisphenol A (BPA-PO).

Among them, preferred polyhydric alcohol is an aliphatic polyhydric alcohol having a carbon number in the range of 5 to 7. Since the aliphatic polyhydric alcohol having 5 to 7 carbon atoms has a relatively small volume (bulkiness), it is easy to make the inter-bond distance of the ester bond uniform in the polyester obtained by synthesis. Furthermore, a portion where the density of ester groups is locally high is less likely to be formed. Specifically, it is assumed that a hydrophilic moiety derived from an ester bond and a hydrophobic moiety derived from a hydrocarbon group are appropriately dispersed, and thus, charge leakage can be suppressed.

In particular, an aliphatic polyhydric alcohol having 5 to 7 carbon atoms is less bulky than bisphenol A or a bisphenol A derivative. Therefore, it is considered that the aliphatic polyhydric alcohol having 5 to 7 carbon atoms can reduce charge leakage as compared with bisphenol A or a bisphenol A derivative.

Examples of the aliphatic polyhydric alcohol having 5 to 7 carbons include pentanediol, neopentyl glycol, hexanediol, heptanediol and cyclohexanediol.

From the viewpoint of suppressing charge leakage, the proportion of bisphenol A or a bisphenol A derivative in the polyhydric alcohol is preferably low.

In the present invention, the content of the structural units derived from bisphenol A or a bisphenol A derivative is 10 mol % or less based on the total moles of the structural units derived from the polyhydric alcohols. It is considered that this can suppress charge leakage and unevenness density of an image to be formed.

The content of the structural units derived from bisphenol A or a bisphenol A derivative with respect to the total moles of the structural units derived from the polyhydric alcohol is preferably lower. Specifically, the content is preferably 5 mol % or less, and more preferably 1 mol % or less.

Note that the structural units derived from a polyhydric alcohol may not contain a structural unit derived from bisphenol A or a bisphenol A derivative at all.

Examples of the esterification catalyst include alkali metal compounds such as sodium and lithium; alkaline earth metal compounds such as magnesium and calcium; metal compounds such as aluminum, zinc, manganese, antimony, titanium, tin, zirconium, and germanium; phosphorous acid compounds; phosphoric acid compounds; and amine compounds.

The polymerization temperature is not particularly limited and is, for example, preferably within the range of 150 to 250° C. The polymerization time is not particularly limited and is, for example, preferably in the range of 0.5 to 10 hours. During the polymerization, the pressure in the reaction system may be reduced as necessary.

The content of the amorphous polyester is preferably 20% by mass or more, and more preferably 50% by mass or more, with respect to the total mass of the binder resin. In addition, the content of the amorphous polyester is preferably 10% by mass or more and more preferably 40% by mass or more with respect to the total mass of the toner base particles.

### (Hybrid Amorphous Polyester Resin)

The amorphous polyester may be a hybrid crystalline polyester in which amorphous polyester polymerized segments and amorphous polymerized segments other than the amorphous polyester are chemically bonded with each other.

### (1.1.1.2) Glass Transition Temperature

From the viewpoint of achieving both sufficient low-temperature fixability and heat-resistant storage property, the glass transition temperature (Tg) of the amorphous resin is preferably in the range of 30 to 70° C. and more preferably in the range of 40 to 65° C.

For example, differential scanning calorimetry (DSC measurement) is performed using a differential scanning calorimeter “DSC7000X” (manufactured by Hitachi, Ltd.) and a thermal analyzer controller “AS3/DX” (manufactured by Hitachi, Ltd.). To be specific, 5 mg of a sample is sealed in a sample container having φ6.8 and H2.5 mm (manufactured by HITACHI, Ltd.) for the AL autosampler and a cover for the AL autosampler (manufactured by HITACHI, Ltd.). This is placed in a sample holder of the “AS3/DX”, and the temperature is changed in the order of temperature increase, temperature decrease, and temperature increase. In the first and second temperature increases, the temperature is increased from 0° C. to 150° C. at a temperature increase rate of 10° C./min, and 150° C. is held for one minute. In the temperature decrease, the temperature is decreased from 150° C. to 0° C. at a temperature decrease rate of 10° C./min, and the temperature is held at 0° C. for 1 minute. The baseline shift in the measurement curve obtained on the second heating is determined. The intersection of an extended line of the baseline before the shift and a tangent line indicating the maximum inclination of the shifted portion of the baseline is defined as the glass transition temperature (Tg). An empty aluminum pan is used for a reference.

### (1.1.1.3) Weight Average Molecular Weight

The weight average molecular weight (Mw) of the amorphous resin is not particularly limited and is, for example, preferably in the range of 10000 to 100000.

The weight average molecular weight of the amorphous resin can be measured in the same manner as the weight average molecular weight of the crystalline resin described below.

### (1.1.2) Crystalline Resin

The toner base particles according to the present invention preferably contain a crystalline resin. When the crystalline resin is contained, the crystalline portion is melted when the temperature exceeds a melting point of the crystalline resin, and the crystalline resin and the amorphous resin are compatibilized with each other, thus improving low-temperature fixability.

In the present invention, the expression “exhibiting crystallinity” means that in an endothermic curve obtained by DSC (differential scanning calorimetry), the curve does not show a stepwise endothermic change but has a clear endothermic peak with regard to the melting point, that is, at the time of temperature increase. The clear endothermic peak refers to a peak having a half value width of 15° C. or less in an endothermic curve when the temperature is increased at a temperature increase rate of 10° C./min.

It is preferable to use, as the crystalline resin, a known crystalline resin, for example, crystalline polyester or crystalline polyurethane resin. In particular, crystalline polyester is preferable from the viewpoints of sharp melting property during melting and compatibility with a binder resin. That is, the moiety having a crystal structure preferably contains a crystalline polyester.

### (1.1.2.1) Crystalline Polyester

The “crystalline polyester” refers to a polyester exhibiting crystallinity among known polyesters obtained by a polycondensation reaction between a carboxylic acid having a valency of 2 or more (polyvalent carboxylic acid) and an alcohol having a valency of 2 or more (polyhydric alcohol).

The crystalline polyester preferably has a structural unit derived from an aliphatic diol and a structural unit derived from an aliphatic carboxylic acid. In addition, it is preferable to have only a structural unit derived from an aliphatic diol and a structural unit derived from an aliphatic carboxylic acid.

The number of carbon atoms of the aliphatic diol or the aliphatic carboxylic acid is more preferably in a range of 6 to 10. When the crystalline polyester has a structure which is not relatively bulky, it is considered that the ester group can be prevented from being locally present at a high density, which prevents leakage of charges.

The polyvalent carboxylic acid is a compound containing two or more carboxy groups in one molecule.

Examples of the polyvalent carboxylic acids include saturated aliphatic dicarboxylic acids such as oxalic acid, malonic acid, succinic acid, adipic acid, sebacic acid, azelaic acid, N-dodecylsuccinic acid, nonanedicarboxylic acid, decanedicarboxylic acid, undecanedicarboxylic acid, dodecanedicarboxylic acid (dodecanedioic acid), and tetradecanedicarboxylic acid (tetradecanedioic acid); alicyclic dicarboxylic acids such as cyclohexanedicarboxylic acid; aromatic dicarboxylic acids such as phthalic acid, isophthalic acid, and terephthalic acid; polycarboxylic acid having 3 or more valences such as trimellitic acid, and pyromellitic acid; and anhydrides of these carboxylic acid compounds. In addition, other examples include alkyl esters having 1 to 3 carbon atoms. The crystalline polyester may contain only one of them, or may contain two or more of them.

The polyhydric alcohol is a compound having two or more hydroxy groups in one molecule.

Examples of the polyhydric alcohol include aliphatic diols such as 1,2-propanediol, 1,3-propanediol, 1,4-butanediol, 1,5-pentanediol, 1,6-hexanediol, 1,7-heptanediol, 1,8-octanediol, 1,9-nonanediol, dodecanediol, neopentyl glycol, and 1,4-butenediol; polyhydric alcohols having 3 or more valences such as glycerin, pentaerythritol, trimethylolpropane, and sorbitol; and the like. The crystalline polyester may contain only one of them, or may contain two or more of them.

A method for synthesizing the crystalline polyester is not particularly limited. The polyester resin can be synthesized by polycondensation (esterification) of the above-described polyhydric alcohol component and polycarboxylic acid component using a known esterification catalyst.

The ratio between the polyhydric alcohol component and the polycarboxylic acid component is not particularly limited. For example, the equivalent ratio of hydroxy groups in the polyhydric alcohol component to carboxy groups in the polycarboxylic acid component is preferably within a range of 1.5/1 to 1/1.5, and more preferably within a range of 1.2/1 to 1/1.2.

Examples of the catalyst that can be used in the synthesis of the crystalline polyester include compounds of alkali metals such as sodium and lithium; compounds of alkaline earth metals such as magnesium and calcium; compounds of metals such as aluminum, zinc, manganese, antimony, titanium, tin, zirconium, and germanium; phosphite compounds; phosphate compounds; and amine compounds.

Specifically, examples of the tin compound include dibutyltin oxide, tin octylate, tin dioctylate, and the salts thereof.

Examples of the titanium compound include titanium alkoxides such as tetra-n-butyl titanate, tetraisopropyl titanate, tetramethyl titanate, and tetrastearyl titanate; titanium acylates such as polyhydroxy titanium stearate; and titanium chelates such as titanium tetraacetylacetonate, titanium lactate, and titanium triethanolaminate.

Examples of the germanium compound include germanium dioxide.

Examples of the aluminum compound include oxides such as poly (aluminum hydroxide), aluminum alkoxides, and tributyl aluminate.

They may be used alone or in combination of two or more.

The polymerization temperature and the polymerization time are not particularly limited, and the pressure in the reaction system may be reduced as necessary during the polymerization.

### (1.1.2.2) Melting Point

From the viewpoint of low-temperature fixability and hot offset resistance, the melting point (Tm) of the crystalline resin is preferably in the range of 55 to 90° C., and more preferably in the range of 60 to 85° C. The melting point of the crystalline resin can be controlled by controlling its resin composition.

When the crystalline resin is a crystalline polyester, the melting point of the crystalline polyester is preferably 75° C. or less.

The melting point (Tm) is a peak top temperature in the endothermic peak, and can be measured by DSC (differential scanning calorimetry).

For example, differential scanning calorimetry (DSC measurement) is performed using a differential scanning calorimeter “DSC7000X” (manufactured by Hitachi, Ltd.) and a thermal analyzer controller “AS3/DX” (manufactured by Hitachi, Ltd.). To be specific, 5 mg of a sample is sealed in a sample container having φ6.8 and H2.5 mm (manufactured by HITACHI, Ltd.) for the AL autosampler and a cover for the AL autosampler (manufactured by HITACHI, Ltd.). This is placed in a sample holder of the “AS3/DX”, and the temperature is changed in the order of temperature increase, temperature decrease, and temperature increase. In the first and second temperature increases, the temperature is increased from 0° C. to 150° C. at a temperature increase rate of 10° C./min, and 150° C. is held for one minute. In the temperature decrease, the temperature is decreased from 150° C. to 0° C. at a temperature decrease rate of 10° C./min, and the temperature is held at 0° C. for 1 minute. The temperature at the top of the endothermic peak in an endothermic curve obtained in the second heating is measured as the melting point.

### (1.1.2.3) Weight Average Molecular Weight

The weight-average molecular weight of the crystalline resin is not particularly limited. From the viewpoint of tacking suppression and low-temperature fixability, the weight average molecular weight is preferably in the range of 1000 to 29000, more preferably in the range of 1000 to 20000, and still more preferably in the range of 1000 to 15000.

The weight average molecular weight of the crystalline resin can be measured by the following method.

For example, an apparatus of gel permeation chromatography “HLC 8320GPC” (manufactured by Tosoh Corp.), in which a column “TSK gel guard column SuperHZ-L”, and three columns “TSK gel Super HZM-M” (all manufactured by Tosoh Corp.) are connected, is used.

The columns (TSK-) are stabilized at 40° C., and tetrahydrofuran (THF) as a carrier-solvent is allowed to flow through the columns at the same temperature at a flow rate of 0.35 m/min. THF solution of the measurement sample (resin) adjusted to have a sample concentration of 1 mg/mL is treated with a roll mill at a room temperature for 10 minutes. The solution is treated with a membrane filter having a pore size of 0.2 μm to obtain a sample solution. The sample solution (10 μL) is injected into the device together with carrier solvent, and the measurement is performed using a refractive index detector (RI detector).

A calibration curve is drawn using polystyrene standard samples having a monodisperse molecular weight distribution. The molecular weight distribution of the measurement sample is calculated based on the calibration curve. The calibration curve is drawn by using 10 samples of “Polystylene Standard Sample TSK standard” manufactured by Tosoh Corp.: “A-500”, “F-1”, “F-10”, “F-80”, “F-380”, “A-2500”, “F-4”, “F-40”, “F-128”, and “F-700”. The data collection interval in the sample analysis is 300 ms.

Alternatively, the crystalline resin and the release agent in the toner may be separated from each other as described below, and then the weight average molecular weight of the crystalline resin may be calculated by the above-described measurement method.

### (Separation of Crystalline Resin)

A case where the crystalline resin is crystalline polyester will be described as an example.

First, the toner is dispersed in ethanol, which is a poor solvent for the toner, and the dispersion is heated to a temperature exceeding the melting points of the crystalline polyester and the release agent. In this step, pressure may be applied as necessary. At this point, the crystalline polyester and the release agent at a temperature exceeding the melting point are dissolved in the ethanol. Thereafter, a mixture of the crystalline polyester and the release agent can be collected from the toner by performing solid-liquid separation. The crystalline polyester and the release agent can be separated from the toner by subjecting the mixture to molecular weight fractionation.

### (Acid Value of Crystalline Resin)

In light of low-temperature fixability and fold fixability, the acid number of the crystalline polymer is preferably in a range of 9 to 30 mgKOH/g, and more preferably in a range of 15 to 23 mgKOH/g.

The acid number of the crystalline polyester is expressed in mg (mgKOH/g) of potassium hydroxide required for neutralizing carboxy groups present in 1 g of the resin. In particular, it is determined by the following method in accordance with JIS K0070-1992.

### (1) Preparation of Regents

### (a) Phenolphthalein Solution

Phenolphthalein (1.0 g) is dissolved in 90 mL of ethanol (95 vol %), and ion-exchanged water is added to obtain 100 mL of phenolphthalein solution.

### (b) Potassium Hydroxide Solution

Special-grade potassium hydroxide (7 g) is dissolved in 5 mL of ion-exchanged water, and ethanol (95 vol %) is added thereto to obtain 1 L of the solution. The solution is placed in an alkali-resistant container so as not to be in contact with carbon dioxide gas or the like, left to stand for 3 days, and then filtered to obtain potassium hydroxide solution. The obtained potassium hydroxide solution is stored in an alkali-resistant container.

### (c) Factor of Potassium Hydroxide Solution

Hydrochloride solution (0.1 mol/L, 25 mL) is placed in a conical flask, and several drops of phenolphthalein are added. The solution is then titrated with potassium hydroxide solution. The factor of the potassium hydroxide solution is determined from the amount of the potassium hydroxide solution required for the neutralization.

### (d) Hydrochloric Acid Solution

Hydrochloride solution (0.1 mol/L) to be used is prepared in accordance with JIS K8001-1998.

### (2) Operation

### (a) Main Test

Toner 2.0 g is precisely weighed into a 200 mL Erlenmeyer flask, 100 mL of mixed solution of toluene:ethanol (2:1), is added to the Erlenmeyer flask, and the toner is allowed to be dissolved over the course of 5 hours. Next, several drops of phenolphthalein solution are added as an indicator to the Erlenmeyer flask, and titration is performed using the potassium hydroxide solution. Note that the end point of the titration is when the pale red color of the indicator continues for about 30 second.

### (b) Blank Test

The same titration as in the above-described main test is performed except that the sample is not used, that is, only the mixed solution of toluene:ethanol (2:1) is used.

### (3) The Acid Value is Calculated by Substituting the Obtained Results into the Following Equation

A=[(C−D)×f×5.611]/S

Where the symbols and numerals represent as follows.
A: acid value (mgKOH/g)
C: the amount (mL) of potassium hydroxide solution added in the main test
D: the amount (mL) of the potassium hydroxide solution added in the blank test
f: the factor of 0.1 mol/L potassium hydroxide-ethanol solution
5.611: the molar mass of potassium hydroxide 5.611 (g/mol)×( 1/10)
S: the mass of sample (g)

### (1.2) Release Agent

The release agent is not particularly limited, and examples thereof include various known release agents. Such agents includes polyolefin waxes such as polyethylene waxes, and polypropylene waxes; branched hydrocarbon waxes such as microcrystalline waxes; long-chain hydrocarbon waxes such as Sasol wax and paraffin waxes; synthetic waxes such as Fischer-Tropsch wax; dialkyl ketone waxes such as distearyl ketone; ester waxes such as carnauba wax, montan wax, behenyl behenate, trimethylolpropane tribehenate, pentaerythritol tetrabehenate, pentaerythritol diacetate dibehenate, glycerol tribehenate, 1,18-octadecanediol distearate, tristearyl trimellitate, and distearyl maleate; amide-based wax such as ethylenediamine behenylamide, and trimellitic acid tristearylamide.

The melting point of the release agent is preferably in the range of 60 to 80° C. When the melting point is 60° C. or higher, the release agent can be prevented from volatilizing and forming fine particles at the time of fixing of the toner, and the environmental load can be reduced. When the melting point is 80° C. or lower, the release agent is melted at the time of fixing of the toner, and separation performance from a fixing member is satisfactory.

The content of the release agent is preferably in a range of 1 to 30% by mass and more preferably in a range of 5 to 20% by mass with respect to the total mass of the binder resin. When the content of the release agent is within the above range, sufficient fixing separability can be obtained.

In addition, the content of the release agent is preferably within a range of 3 to 15% by mass with respect to the total mass of the toner base particles.

### (13) Coloring Agent

The colorant is not particularly limited, and examples thereof include various known dyes and pigments.

Examples of a colorant for obtaining a black toner include carbon blacks such as furnace black and channel black; magnetic materials such as magnetite and ferrite; dyes; and inorganic pigments including nonmagnetic iron oxide.

Examples of the colorant for obtaining a color toner include known dyes and organic pigments.

Examples of the organic pigments include C.I. Pigment Reds 5, 48:1, 53:1, 57:1, 81:4, 122, 139, 144, 149, 166, 177, 178, 222, 238, and 269, C.I. Pigment Yellows 14, 17, 74, 93, 94, 138, 155, 180, and 185, C.I. Pigment Oranges 31, and 43, C.I. Pigment Blue 15:3, 60, and 76, and the like.

Examples of the dyes include C.I. Solvent Reds 1, 49, 52, 58, 68, 11, and 122, C.I. Solvent Yellows 19, 44, 77, 79, 81, 82, 93, 98, 103, 104, 112, and 162, C.I. Solvent Blues 25, 36, 69, 70, 93, and 95, and the like.

The colorant for obtaining the toner of each color may be contained alone or in combination of two or more kinds for each color.

The content of the colorant is preferably in the range of 1 to 10% by mass and more preferably in the range of 2 to 8% by mass with respect to the total mass of the binder resin.

### (14) Charge Control Agent

Examples of the charge control agent include various known compounds.

The content of the charge control agent is preferably in the range of 0.1 to 5.0% by mass with respect to the total mass of the binder resin.

### (2) External Additives

In the toner according to the present invention, an external additive may be further added to the toner base particles. Addition of an external additive can further improve the fluidity, chargeability, cleanability, and the like of the toner.

Examples of the external additive include inorganic oxide fine particles such as silica fine particles, alumina fine particles, and titanium oxide fine particles; inorganic stearate compound fine particles such as aluminum stearate fine particles, and zinc stearate fine particles; and inorganic titanate compound fine particles such as strontium titanate, and zinc titanate. They may be used alone or in combination of two or more.

From the viewpoint of heat-resistant storage property and environmental stability, these inorganic fine particles are preferably subjected to hydrophobization treatment with a silane coupling agent, a titanium coupling agent, a higher fatty acid, silicone oil or the like.

The total amount of the external additives added is preferably in the range of 0.05 to 5 mass % and more preferably in the range of 0.1 to 3 mass % with respect to the total mass of the toner.

### 3. Physical Properties of Electrostatic Charge Image Developing Toner

### (1) Particle Size of Toner Particles

The average particle size of the toner particles is, for example, preferably within a range of 3 to 10 μm, and more preferably within a range of 4 to 8 μm, in terms of a volume-based median diameter (d50).

The average particle diameter of the toner particles can be controlled by controlling the concentration of a coagulant used in the production, the amount of an organic solvent added, a fusion time, the composition of the binder resin, and the like.

When the volume-based median size (d50) is within the above range, a very fine dot image at the 1200 dpi level can be faithfully reproduced.

The volume-based median size (d50) of the toner particles is calculated and determined by using a measurement device in which “Multisizer 3” (manufactured by Beckman Coulter, Inc.) is connected to a computer system equipped with the software for data processing “Software V3.51.

Specifically, first, a toner sample to be measured is added to a surfactant solution to be mixed, diluted with pure water, and then subjected to ultrasonic dispersion to prepare toner particle dispersion. As the surfactant solution, for example, an anionic surfactant such as sodium polyoxyethylene lauryl ether sulfate is suitably used for the purpose of dispersing the toner particles.

The toner particle dispersion is injected into a beaker containing “ISOTONII” (manufactured by Beckman Coulter, Inc.) placed in a sample stand with a pipette until the concentration displayed in the measurement device reaches 6 to 8%. With this concentration, a measurement value can be obtained with high reproducibility.

Next, in the measurement device, the particle count number to be measured is set to 25000, and the aperture diameter is set to 100 μm. The range of 2 to 60 μm, which is the measurement range of the particle size of the toner particles, is divided into 256 segments, and the frequency value of the particle size of the toner particles is calculated. The particle size of 50% particles from the largest volume integrated fraction is defined as a volume-based median diameter (d50).

### (2) Average Circularity of Toner Particles

From the viewpoint of the stability of charging characteristics and low-temperature fixability, the average circularity of the toner particles is preferably in the range of 0.930 to 1.000, and more preferably in the range of 0.950 to 0.995.

When the average circularity is within the above range, both toner transferability and cleaning performance can be achieved, toner chargeability is stable, and a high-quality image can be formed.

The average circularity of the toner particles can be measured using, for example, a flow particle image analyzer “FPIA-3000” (manufactured by Sysmex Corporation).

Specifically, a toner sample to be measured is added to and mixed with a surfactant solution, diluted with pure water, and then subjected to ultrasonic dispersion to prepare a toner particle dispersion. As the surfactant solution, for example, an anionic surfactant such as sodium polyoxyethylene lauryl ether sulfate is suitably used for the purpose of dispersing the toner particles. Then, for example, using a flow-type particle image analyzer “FPIA-3000” (manufactured by Sysmex Corporation), an image is captured at an appropriate density, i.e. an HPF detection number of 3000 to 10,000, in a measurement condition of the HPF (high magnification imaging) mode.

The circularity of each of the toner particles is calculated using the following equation. Next, the average circularity is calculated by adding the circularity of each toner particle and dividing the sum by the total number of toner particles. When the number of HPF detections is within the above range, high reproducibility is obtained.

Circularity=(Perimeter of circle having the same projected area as particle image)/(Perimeter of particle projection image)

### (3) Glass Transition Temperature of Toner

From the viewpoint of achieving both sufficient low-temperature fixability and heat-resistant storage property, the glass transition temperature (Tg) of the toner is preferably within a range of 15 to 40° C. and more preferably within a range of 20 to 35° C. The glass transition temperature can be measured by the above-described method.

### 4. Structure of Electrostatic Charge Image Developing Toner

### (Core-Shell Structure)

The toner base particles may have a multilayer structure. Examples of the multilayer structure include a core-shell structure including a core particle and a shell layer covering the surface of the core particle.

The shell layer may not cover the entire surface of the core particle, or the core particle may be partially exposed. The cross section of the core-shell structure can be confirmed by a known observation means such as a transmission electron microscope (TEM) or a scanning probe microscope (SPM).

When the toner base particles have a core-shell structure, the core particles and the shell layers may have different properties, for example in glass transition temperature, melting point, and hardness, depending on the purpose. For example, core particles containing a binder resin, a colorant, a release agent, and the like and having a relatively low glass transition temperature (Tg) are prepared. Then, a resin having a relatively high glass transition temperature (Tg) is aggregated and fused with the core particles to form shell layers. The shell layers preferably contain an amorphous resin. Such a configuration allows for both low-temperature fixability and heat-resistant storage stability. In addition, satisfactory charge retention performance is obtained.

### 5. Method for Producing Electrostatic Charge Image Developing Toner

The method for producing an electrostatic charge image developing toner of the present invention is a method for producing the above-described electrostatic charge image developing toner, and includes a step of drying the wet toner base particles by an airflow in a dryer. The temperature of the airflow is ≥60° C. and the speed of the airflow is ≥5 m/sec.

The method for producing the toner base particles is not particularly limited, provided that the method includes the steps of producing wet toner base particles and drying the wet toner base particles. Examples of the production method include a suspension polymerization method, an emulsion aggregation method, and other known methods. Among them, the emulsion aggregation method is preferable. By using the emulsion aggregation method, a toner can be produced with suppressed cost and stable quality. Thus, toner particles having a small particle size can be easily produced.

In the emulsion aggregation method, first, an aqueous dispersion of amorphous polyester fine particles and, if necessary, an aqueous dispersion of fine particles of a release agent, a colorant, an amorphous resin other than the amorphous polyester, a crystalline resin, and the like are mixed together. Then, these fine particles are aggregated to form wet toner base particles.

In the present invention, the wet toner base particles are dried under specific conditions to produce toner base particles.

As used herein, the term “aqueous dispersion” refers to a material in which dispersions (particles) are dispersed in an aqueous medium. The aqueous medium refers to a medium in which the main component, that is, a component occupying 50% by mass or more is water.

Examples of the components other than water contained in the aqueous medium include organic solvents that dissolve in water. Examples of the water-soluble organic solvents include methanol; ethanol; isopropanol; butanol; acetone; methyl ethyl ketone and tetrahydrofuran. Among these, from the viewpoint of not dissolving the resin, an alcohol-based organic solvent such as methanol, ethanol, isopropanol, and butanol are preferable.

Hereinafter, an example of the method for producing an electrostatic charge image developing toner will be described, but the present invention is not limited thereto.
(1) Synthesizing an amorphous polyester to prepare a dispersion of amorphous polyester fine particles;
(2) Synthesizing a crystalline polyester to prepare a dispersion of crystalline polyester fine particles
(3) Preparing a dispersion of release agent fine particles
(4) Preparing a dispersion of colorant fine particles
(5) Forming toner base particles by aggregating amorphous polyester fine particles, crystalline polyester fine particles, release agent fine particles, and colorant fine particles
(6) Aging toner base particles with thermal energy to control the shape of the toner base particles
(7) Cooling the dispersion of toner base particles
(8) Separating the toner base particles from the aqueous medium by filtration, and washing the toner base particles to remove the surfactant and the like therefrom, thereby obtaining wet toner base particles
(9) Desolvating the wet toner base particles
(10) Drying the wet toner base particles with an airflow in a dryer
(11) Adding an external additive to the dried toner base particles

### (1) Synthesizing an Amorphous Polyester to Prepare a Dispersion of Amorphous Polyester Fine Particles;

In this step, the amorphous polyester is synthesized by a conventionally known method, and the amorphous polyester is dispersed in the form of fine particles in an aqueous medium to prepare a dispersion of amorphous polyester fine particles.

Specifically, first, the amorphous polyester is dissolved or dispersed in an organic solvent to prepare an oil phase liquid. Next, the oil phase liquid is dispersed in an aqueous medium by phase inversion emulsification or the like to form oil droplets controlled to have a desired particle diameter. Thereafter, the organic solvent is removed to prepare an aqueous dispersion of amorphous polyester fine particles.

The amount of the aqueous medium used is preferably in a range of 50 to 2000% by mass and more preferably in a range of 100 to 1000% by mass with respect to the total mass of the oil phase liquid.

A surfactant or the like may be added to the aqueous medium from the viewpoint of the dispersion stability of the oil droplets. Examples of the surfactant include various conventionally known anionic surfactants, cationic surfactants, and nonionic surfactants.

From the viewpoint of removal treatment after formation of oil droplets, the organic solvent used in the preparation of the oil phase liquid preferably has a low boiling point and low solubility in water. Specific examples thereof include methyl acetate, ethyl acetate, methyl ethyl ketone, methyl isobutyl ketone, toluene, and xylene.

They may be used alone or in combination of two or more.

The amount of the organic solvent used is preferably in the range of 1 to 300% by mass with respect to the total mass of the amorphous polyester.

The emulsification and dispersion of the oil phase liquid can be achieved using mechanical energy.

Internal additives such as a release agent and a charge control agent may be contained in the toner base particles as necessary. Such an internal additive may be introduced into the toner base particles, for example, by dissolving or dispersing the internal additive in a monomer solution for synthesizing the amorphous polyester in advance.

The amorphous polyester fine particles preferably have an average particle size in the range of 100 to 400 nm in terms of volume-based median size (d50). The volume-based median size (d50) can be measured using, for example, “Microtrac UPA-150” (manufactured by Nikkiso Co., Ltd).

### (2) Synthesizing a Crystalline Polyester to Prepare a Dispersion of Crystalline Polyester Fine Particles

The aqueous dispersion of crystalline polyester fine particles can also be prepared in the same manner as the aqueous dispersion of amorphous polyester fine particles. If necessary, the temperature at the time of dispersion is preferably adjusted.

### (3) Preparing a Dispersion of Release Agent Fine Particles

This step is performed as necessary when a release agent is contained in the toner base particles.

The aqueous dispersion of release agent fine particles can be prepared by dispersing a release agent in an aqueous medium to which a surfactant has been added in an amount equal to or more than the critical micelle concentration (CMC).

The release agent can be dispersed by utilizing mechanical energy. The disperser is not particularly limited, and examples thereof include ultrasonic dispersers; mechanical homogenizers; pressurized dispersers such as Manton-Gaulin and pressure-type homogenizers; and medium-type dispersers such as a sand grinder and a diamond fine mill.

The volume-based median size (d50) of the release agent fine particles in a dispersed state is preferably in a range of 10 to 300 nm, more preferably in a range of 100 to 200 nm, and particularly preferably in a range of 100 to 150 nm. The volume-based median diameter (d50) of the release agent fine particles can be measured, for example, with an electrophoretic light scattering photometer “ELS-800” (manufactured by Otsuka Electronics Co., Ltd).

### (4) Preparing a Dispersion of Colorant Fine Particles

The aqueous dispersion of colorant fine particles can be prepared in the same manner as the aqueous dispersion of release agent fine particles. The release agent fine particles are preferably heated to a melting point or higher for dispersion, but the colorant fine particles are not necessarily heated.

### (5) Forming Toner Base Particles by Aggregating Amorphous Polyester Fine Particles, Crystalline Polyester Fine Particles, Release Agent Fine Particles, and Colorant Fine Particles

In this step, a coagulant is added to the aqueous dispersion in which the above-described fine particles are dispersed, in an amount equal to or more than the critical coagulation concentration. Then, the temperature of the reaction liquid is adjusted to aggregate the fine particles, thereby forming toner base particles.

The aggregating agent is not particularly limited, but is preferably, for example, a metal salt such as an alkali metal salt or an alkaline earth metal salt. Examples of the metal salts include salts of monovalent metals such as sodium, potassium, and lithium; salts of divalent metals such as calcium, magnesium, and manganese; salts of trivalent metals such as iron, and aluminum; and the like.

Specific examples of the metal salt include sodium chloride, potassium chloride, lithium chloride, calcium chloride, magnesium chloride, zinc chloride, copper sulfate, magnesium sulfate, manganese sulfate, aluminum chloride, aluminum sulfate, polyaluminum chloride, and polyaluminum hydroxide. Among them, the metal salt is preferably a trivalent metal salt from the viewpoint of the ability to causing aggregation with a smaller amount.

They may be used alone or in combination of two or more.

(6) Aging Toner Base Particles with Thermal Energy to Control the Shape of the Toner Base Particles

This step is performed as necessary when the toner base particles are aged by thermal energy to control their shapes.

Specifically, in the aging treatment, the dispersion liquid of the toner base particles is heated and stirred while adjusting the heating temperature, the stirring speed, the heating time, and the like, so that the circularity of the toner base particles becomes a desired value.

### (7) Cooling the Dispersion of Toner Base Particles

In this step, the dispersion of the toner base particles is cooled. The cooling rate is preferably within a range of 1 to 20° C./min. The specific method of the cooling treatment is not particularly limited. The example methods include a cooling method by introducing a refrigerant from the outside of the reaction vessel, a cooling method by directly charging cold water into the reaction system, a cooling method by using a heat exchanger and the like.

(8) Separating the Toner Base Particles from the Aqueous Medium by Filtration, and Washing the Toner Base Particles to Remove the Surfactant and the Like Therefrom, Thereby Obtaining Wet Toner Base Particles

In this step, the toner base particles are subjected to solid-liquid separation from the cooled dispersion of the toner base particles. Next, the obtained toner cake is washed to remove adhered substances such as the surfactant and the flocculant, thereby obtaining wet toner base particles. The “toner cake” as used herein refers to an aggregate of wet toner base particles aggregated in a cake form.

The method of solid-liquid separation is not particularly limited, and examples thereof include centrifugation; a vacuum filtration method using a Nutsche filter or the like; and a filtration method using a filter press or the like. In the washing, the filtrate is preferably washed with water until the electrical conductivity of the filtrate becomes less than 10 pS/cm.

### (9) Desolvating the Wet Toner Base Particles

This step is performed as necessary when the amount of the solvent contained in the wet toner base particles is reduced.

By performing the desolvation treatment, the amount of the solvent contained in the obtained wet toner base particles can be reduced. In addition, the amount of the solvent contained in the obtained wet toner base particles can be adjusted by adjusting the time, rotation conditions, pressurization conditions, and the like in the desolvation treatment.

(10) Drying the Wet Toner Base Particles with an Airflow in a Dryer

In this step, the wet toner base particles subjected to the washing treatment and further subjected to the desolvation treatment in some cases are dried by an airflow in the dryer. The temperature of the airflow is 60° C. or more, and the velocity of the airflow is 5 m/sec or more. By drying the toner having the specific configuration under these conditions, the toner base particles can be dried rapidly at a relatively high temperature. Thus, the distribution of the solvent in the toner base particles can be made uniform. The “solvent” as used herein is mainly water, and further includes the organic solvents used in production of toner base particles.

(10.1) Drying with Airflow

In the method for producing a toner having the above-described specific configuration, the wet toner base particles are dried with an airflow, and the temperature and speed of the airflow are set within specific ranges, whereby the presence state of the solvent in the toner base particles can be made uniform. Specifically, water molecules and the like adsorbed on the outermost layer of the toner base particles can be removed, and water molecules and the like inside the toner base particles can be uniformly dispersed. Thus, it is considered that the charge retention performance of the toner is improved and a high-quality image is obtained.

The dryer is not particularly limited as long as it is an apparatus (flash dryer) that uses an airflow for drying, and examples thereof include a continuous instantaneous flash dryer, a fluidized bed dryer, and a vibration fluidized bed dryer. Among them, from the viewpoint of the recovery rate of the toner, a continuous instantaneous airflow dryer is preferable, and specifically, “Flash Jet Dryer” (manufactured by Seishin Enterprise Co., Ltd.) is preferable.

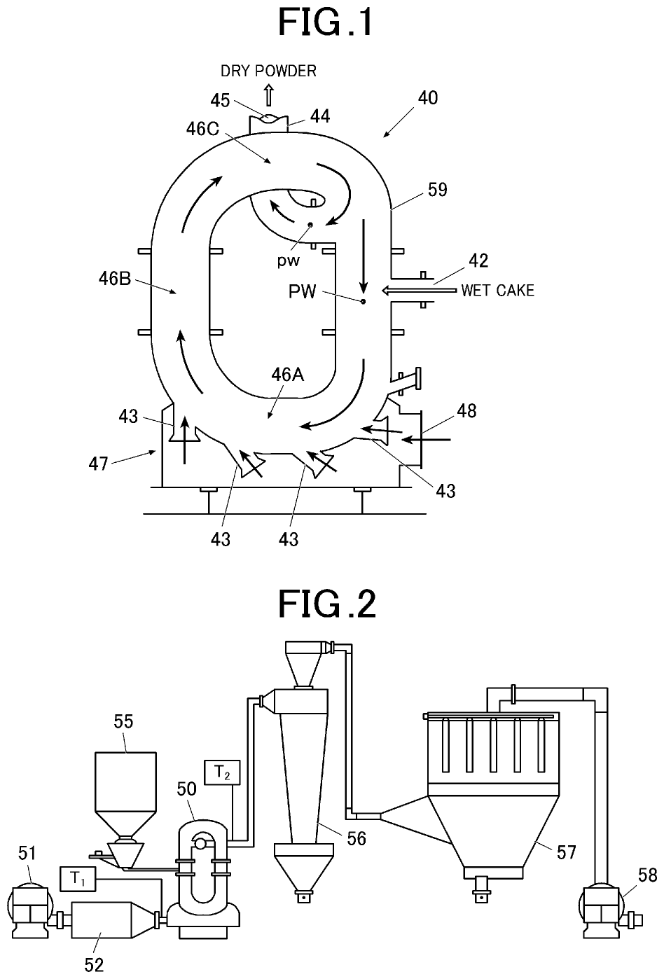

The dryer has a space (chamber), i.e., a drying unit, in which wet toner base particles to be dried are mixed with a high-temperature airflow so that the particles are dried in the airflow. In addition, the dryer has a charging port for charging wet toner base particles into the drying unit, a supply port for supplying a heated airflow, and a discharge port for dried toner base particles. The dryer may have any shape, but a piping type is preferable. Specifically, preferable is a piping type in which the toner particles are dried while being conveyed by an airflow in a pipelike chamber as illustrated in FIG. 1. In order to perform drying with this dryer, a hot air supply unit, a collecting unit, and a wet toner base particle supply unit are connected to the dryer. The hot air supply means is a means for blowing hot air from a hot air supply port of the dryer. The collecting unit is a unit that collects the dried toner base particles from the discharge port of the dryer. The means for supplying the wet toner base particles is a means for charging the wet toner base particles through a charging port of the dryer.

FIG. 1 is an explanatory diagram illustrating an example of a flash dryer. In the figure, the reference numeral 40 is denoted to a flash dryer, 42 to a charging port for wet toner base particles, 43 to a nozzle, 44 is a collection nozzle, and 45 is a discharge port for dried toner base particles. In the figure, the reference numeral 46A is denoted to a drying region, 46B to an up-stack region, 46C to a classification region, 47 to a hot air supply portion, and 48 to a hot air inlet. The wet toner base particles are charged in the form of a cake.

The heated compressed air is supplied through the hot air inlet 48 into the hot air supply region 47. The compressed air (hot air) is ejected at a supersonic speed into the flash dryer 1 through the nozzles 43 that open to the hot-air supply portion 47. The hot air circulates inside the flash dryer 40 along the flow path in the order of the drying region 46A, the up-stacking region 46B, the classification region 46C, and the drying region 46A. During this, the inside of the flash dryer 40 has a slightly negative pressure in the vicinity of the charging port 42.

When wet toner base particles in a cake form (water-containing cake) are supplied from the charging port 42, the toner base particles are dispersed and crushed (powdered) by hot air circulating inside the flash dryer 40. Then, the solvent in the formed powder is rapidly removed. The powder of the toner base particles is conveyed to the classification region 46C by the hot air.

The dry powder pw in which the solvent in the powder is equal to or less than a predetermined value, that is, the low-specific-gravity dry powder pw is discharged from the discharge port 45 through the collection nozzle 44. The powder PW in which the solvent in the powder is greater than a predetermined value, that is, the high-specific-gravity powder PW is conveyed to the drying region 46A and is subjected to the drying treatment again.

By using the flash dryer, the solvent present in the wet toner base particles can be evaporated instantaneously, for example, within one minute. Next, only the powder (dry powder pw) having a solvent content equal to or less than a predetermined value is classified and ejected from the flash dryer. The particle group formed of the dry powder pw has a desired particle size distribution and does not aggregate. In addition, the classified and discharged dry powder pw has extremely small variation in specific gravity among particles, that is, in residual solvent amount.

The specific gravity of the dry powder pw can be controlled by adjusting the classification conditions in the classification region 46C, that is, the centrifugal force acting on the powder. Specifically, for example, it can be controlled by adjusting the amount of hot air supplied (air volume) into the hot-air supplying portion 47.

The drying treatment with the flash dryer may be performed in a continuous manner or a batch manner. However, from the viewpoint of eliminating variation in drying between particles, it is preferable to adopt the continuous manner. As used herein, the “continuous manner” refers to a manner in which the supply of wet toner base particles and the discharge of dried toner base particles are continuously performed.

FIG. 2 is an explanatory diagram illustrating an example of a plant for performing a continuous drying treatment; In the figure, the reference numeral 50 is denoted to a flash dryer having the configuration illustrated in FIG. 1. The reference numeral 51 is denoted to a blower that generates compressed air, and 52 to a heater that heats the air from the blower 51. The air (hot air) heated by the heater 52 is supplied to the hot air supply unit (the hot air supply unit 47 in FIG. 1) of the flash dryer 50.

T₁ is a thermometer for measuring the temperature of the air heated by the heater 52. Hereinafter, the temperature of the air heated by the heater 52 is also referred to as an “inlet temperature”. T 2 is a thermometers for measuring the temperature of the air exhausted from the flash dryer 50. Hereinafter, the temperature of the air discharged from the flash dryer 50 is also referred to as “outlet temperature”.

Reference numeral 55 is denoted to a feeder of wet toner base particles, and this feeder 55 is connected to a charging port (the charging port 42 in FIG. 1) of the flash dryer 50. Reference numeral 56 is denoted to a cyclone connected to a discharge port (the discharge port 45 in FIG. 1) of the flash dryer 50 via a pipe. The dried toner base particles are collected from a powder outlet of the cyclone 56. Reference numeral 57 is denoted to a bag filter connected to an exhaust port of the cyclone 56 via a pipe, and reference numeral 58 is denoted to an exhaust blower connected to the bag filter 57 via a pipe.

### (Temperature of Airflow)

In the present invention, the “temperature of airflow” refers to the temperature of an airflow supplied to a housing or piping for drying wet toner base particles, and refers to the “inlet temperature” in the flash dryer.

Specifically, the temperature T₁ at the outlet of the heater 52 illustrated in FIG. 2 is measured.

From the viewpoint of charge retention performance of the toner, the temperature of the airflow is preferably 65° C. or higher, and more preferably 70° C. or higher.

### (Speed of Airflow)

In the present invention, the “speed of airflow” refers to a value calculated from the air volume supplied to a dryer (housing or piping) for drying wet toner base particles at 0° C. and 1 atm equivalent and the maximum value of the cross-sectional area in the direction vertical to the direction of airflow in the drying section of the dryer for drying wet toner base particles. In FIG. 2, the dryer for drying the wet toner base particles is denoted by reference numeral 50. The dryer of FIG. 1 is a piping type, and the cross-sectional area herein is a cross-sectional area of the piping. To be precise, it is the cross-sectional area of a portion where no nozzle is provided, such as the charging port 42 for wet toner base particles, the nozzle 43, the collection nozzle 44, and the discharge port 45 for dried toner base particles. When the cross-sectional area varies, the maximum value of the cross-sectional area is used for the calculation. In the case where the drying unit is not of a pipe type and the airflow is blown into, for example, a cylindrical drying unit, the maximum cross-sectional area of the drying unit in the direction perpendicular to the direction in which the airflow is blown is used. The cross-sectional area in this case is a cross-sectional area at a portion where no nozzle is provided, such as a wet toner base particle charging port, an airflow inlet port, and a dry toner collection port.

Specifically, it refers to the speed of an airflow measured by the following measurement method.

An orifice is installed at the outlet of the blower 51 shown in FIG. 2, the airflow velocity is calculated from the pressure difference between the front and back, and the air volume is calculated from the temperature, absolute pressure, and gas density. In addition to the orifice, a pitot tube, a hot-wire sensor, or the like can be used for measuring the wind speed.

The “air volume” refers to the amount (volume) of air passing per unit time.

The velocity of the airflow is calculated by the following equation.

Velocity of airflow=Volume of air supplied to dryer at 0° C. and 1 atm equivalent/Maximum value of cross-sectional area perpendicular to direction of airflow in drying section of dryer

From the viewpoint of charge retention performance of the toner, the velocity of the airflow is preferably 8 m/sec or higher, and more preferably 10 m/sec or higher. In addition, the upper limit of the velocity is not particularly limited and may be, for example, 50 m/sec or less. From the viewpoints of suppressing aggregation of the toner and improving production efficiency, the velocity of the airflow is preferably 35 m/sec or less. In addition, the velocity of the airflow is more preferably 20 m/sec or less.

It is assumed that when the content of the solvent in the wet toner base particles is reduced as compared with the case of general flash drying, the solvent contained in the toner base particles tends to be uniform in the particles. Then, the residual solvent in the particles is made uniform without unevenness, and thereby the charge retaining performance of the toner is assumed to be improved. When the toner base particles contain the specific resin, it is assumed that excessive drying can be prevented even when the content of the solvent is reduced.

The content of the solvent in the wet toner base particles is preferably in a range of 15 to 30% by mass and more preferably in a range of 15 to 25% by mass. When the content is within the above range, the residual solvent in the particles can be made uniform without unevenness. Furthermore, drying unevenness and aggregation of the toner base particles can be suppressed.

If necessary, the content of the solvent in the wet toner base particles can be adjusted by the above-described desolvation treatment. The content of the solvent in the wet toner base particles can be measured by a Karl Fischer method or a heat drying mass measurement method.

From the viewpoint of the charge retention performance of the toner, the temperature (outlet temperature) of the compressed air discharged from the flash dryer is preferably (Tg±10°) C, where Tg is the glass transition temperature of the toner. In addition, when the outlet temperature is (Tg−10°) C or more, a sufficient evaporation rate of the solvent can be obtained, and formation of a water bridge between the toner base particles and aggregation thereof can be suppressed. When the outlet temperature is (Tg+10°) C or lower, it is possible to prevent the surfaces of the obtained toner base particles from being softened and causing aggregation. The glass transition temperature (Tg) of the toner is preferably within a range of 15 to 40° C. and more preferably within a range of 20 to 35° C.

In the drying process, the residual solvent amount of the toner base particles discharged from the flash dryer is measured. Then, the amount of the wet toner base particles supplied to the flash dryer is preferably controlled so that the residual solvent amount is maintained at a predetermined value or less. The residual solvent amount of the discharged toner base particles can be measured by a Karl Fischer method or a heat drying mass measurement method.

In the drying treatment, the outlet temperature of the flash dryer is constantly measured, and the amount of the wet toner base particles supplied to the flash dryer is preferably controlled so that the outlet temperature is maintained within a certain range. Thus, the amount of the residual solvent in the ejected toner base particles can be controlled within a certain range.

The amount of residual solvent in the dried toner base particles is preferably 2% by mass or less, and more preferably 1% by mass or less. When the content is within the above range, the amount of water contained in the toner base particles can be made relatively low. Thus, a toner having excellent charge retention performance is obtained.

### (10.2) Post-Drying

After the wet toner base particles are dried with an airflow, post-drying may be further performed for adjustment of the amount of residual solvent and the amount of other non-volatile substances in the toner.

Examples of the dryer used in the post-drying treatment include a vacuum freeze dryer, a reduced pressure dryer, a stationary shelf dryer, a movable shelf dryer, a fluidized bed dryer, a vibrating fluidized bed dryer, a rotary dryer, and a stirring dryer. Of these, a fluidized bed dryer and a vibrating fluidized bed dryer are preferable.

When the dried toner base particles are aggregated by a weak inter-particle attractive force, the aggregate may be subjected to a crushing treatment. Examples of the crushing apparatus include mechanical crushing apparatuses such as a jet mill, a Henschel mixer, a coffee mill, and a food processor.

### (11) Adding an External Additive to the Dried Toner Base Particles

This step is performed as necessary when an external additive is added to the toner base particles.

The toner base particles can be directly used as a toner as they are. Furthermore, from the viewpoint of fluidity, chargeability, cleanability, and the like, external additives such as a so-called fluidizing agent and a cleaning aid may be added to the toner base particles.

Examples of a mixing device for an external additive include mechanical mixing devices such as a Henschel mixer and a coffee mill.

The method for producing an electrostatic charge image developing toner of the present invention includes at least the above-described step (10). The method may further include Step (9) as necessary. Steps (1) to (9) described above are an example of the method of producing toner base particles, but the method is not limited thereto.

The toner base particles according to the present invention may have a core-shell structure. Further, having the shell layer makes it possible to achieve both low-temperature fixability and heat resistance. When the shell layer is formed, the shell layer is preferably formed after the core particles are formed in Step (5). The shell layer is preferably formed of an amorphous resin. A method for forming the shell layer is not particularly limited, and a conventionally known method can be used.

### 6. Developer

The toner can be used as a magnetic or non-magnetic mono-component developer. Further, the toner may be mixed with a carrier to form a two-component developer.

When the toner is used as a two-component developer, magnetic particles formed of a conventionally known material can be used as the carrier. Examples of the material of the magnetic particles include metals such as iron, ferrite, and magnetite; and alloys of these metals with metals such as aluminum and lead. Among them, the magnetic particles are preferably ferrite particles.

The carrier may be a coated carrier in which the surface of magnetic particles is coated with a coating agent such as a resin, a dispersion type carrier in which a magnetic fine powder is dispersed in a binder resin, or the like.

The volume-based median diameter (d50) of the carrier is preferably within a range of 20 to 100 μm, and more preferably within a range of 25 to 80 μm. The volume-based median diameter (d50) of the carrier can be measured, for example, with a laser diffraction particle size distribution analyzer “HELOS” (manufactured by SYMPATEC GmbH) equipped with a wet disperser.

A mixing device to be used for mixing the toner and the carrier is not particularly limited, and examples thereof include a Nauta mixer, a W-cone type mixer, and a V-type mixer.

The content of the toner in the developer is preferably in a range of 4.0 to 8.0 mass % with respect to the total mass of the developer.

### 7. Image Forming Method

It is preferable to form an image by an electrophotographic method using the developer. The developer may be either magnetic/non-magnetic mono-component/two-component developer.

Hereinafter, an example of the image forming method using a two-component developer will be described, but the present invention is not limited thereto.

The electrophotographic method preferably includes a charging step of charging a surface of an image carrier member, an electrostatic charge image forming step of forming an electrostatic charge image on the charged surface of the image carrier member, a developing step of developing the electrostatic charge image formed on the surface of the image carrier member as a toner image using the developer, a transfer step of transferring the toner image formed on the surface of the image carrier member onto a surface of a recording medium, a fixing step of fixing the toner image transferred onto the surface of the recording medium, and a cleaning step of cleaning the surface of the image carrier member.

### Charging Step

In this step, the electrophotographic photoreceptor is charged. The charging method is not particularly limited, and for example, a known method such as a charging roller method in which the electrophotographic photoreceptor is charged with a charging roller can be used.

### Electrostatic Charge Image Forming Step

In this step, an electrostatic charge image is formed on the electrophotographic photoreceptor (electrostatic charge image carrier)

The electrophotographic photoreceptor is not particularly limited, and for example, a drum-shaped organic photoreceptor can be used.

The formation of the electrostatic charge image is performed, for example, by uniformly charging the surface of the electrophotographic photoreceptor with a charging unit and exposing the surface of the electrophotographic photoreceptor with an exposing unit corresponding to the image.

The term “electrostatic charge image” refers to an image formed on the surface of the electrophotographic photoreceptor by such a charging means.

The charging means and the exposure means are not particularly limited, and known methods can be used in electrophotographic method.

### Developing Step

In this step, the electrostatic charge image is developed with the developer to form a toner image.

The toner image is formed with the developer by developing means that is composed of a stirrer for frictionally stirring and charging the toner, and a rotatable magnet roller.

Specifically, in the developing means, for example, the toner and the carrier are mixed and stirred, and the toner is charged by the friction. The toner is held on the surface of the rotating magnet roller to form a magnetic brush. The magnet roller is disposed in the vicinity of the electrophotographic photoreceptor. Part of the toner constituting the magnetic brush moves to the surface of the electrophotographic photoreceptor by an electrical attraction force. As a result, the electrostatic charge image is developed with the toner, and a toner image is formed on the surface of the electrophotographic photoreceptor.

### Transferring Step

In this step, the toner image is transferred to a recording medium.

The transfer is performed by peeling the toner image onto the recording medium.

Examples of the transfer means include a corona transfer device using corona discharge, a transfer belt, and a transfer roller.

In the transfer step, for example, an intermediate transfer member is used, and the toner image is primarily transferred onto the intermediate transfer member. Thereafter, the toner image is secondarily transferred onto a recording medium. Alternatively, the toner image formed on the electrophotographic photoreceptor may be directly transferred onto a recording medium.

### Fixing Step

In this step, the unfixed image (toner image) is fixed onto the recording medium. Fixing is performed by passing a recording medium, onto which an unfixed image (toner image) has been transferred, between the heated fixing belt or fixing roller and a pressure member.

The method of the fixing step is, for example, a belt fixing method or a roller fixing method. In these methods, the fixing member is constituted by a fixing belt or a fixing roller as a fixing rotatable member and a pressure roller. The pressure roller is provided in a state of being pressed against and contacting the fixing belt or the fixing roller so that a fixing nip portion is formed.

### Cleaning Step

In this step, the developer that has not been used for image formation or that has not been transferred and remains on the developer carrier such as the photoreceptor or the intermediate transfer member is removed from the developer carrier.

The method of cleaning is not particularly limited. For example, a blade that rubs the surface of the photoreceptor can be used. The blade is provided such that a distal end of the blade is in contact with a cleaning target such as the photoreceptor.

### Recording Medium

The recording medium is not particularly limited. Examples of the recording medium include: paper such as normal paper ranging from thin paper to cardboard, wood-free paper, coated printing sheet such as art paper or coated paper, commercially available Japanese paper or postcard sheet; a resin film such as a polypropylene (PP) film, a polyethylene terephthalate (PET) film and a triacetyl cellulose (TAC) film; and a fabric. The color of the recording medium is not particularly limited, and recording media of various colors can be used.

### 8. Image Forming Apparatus

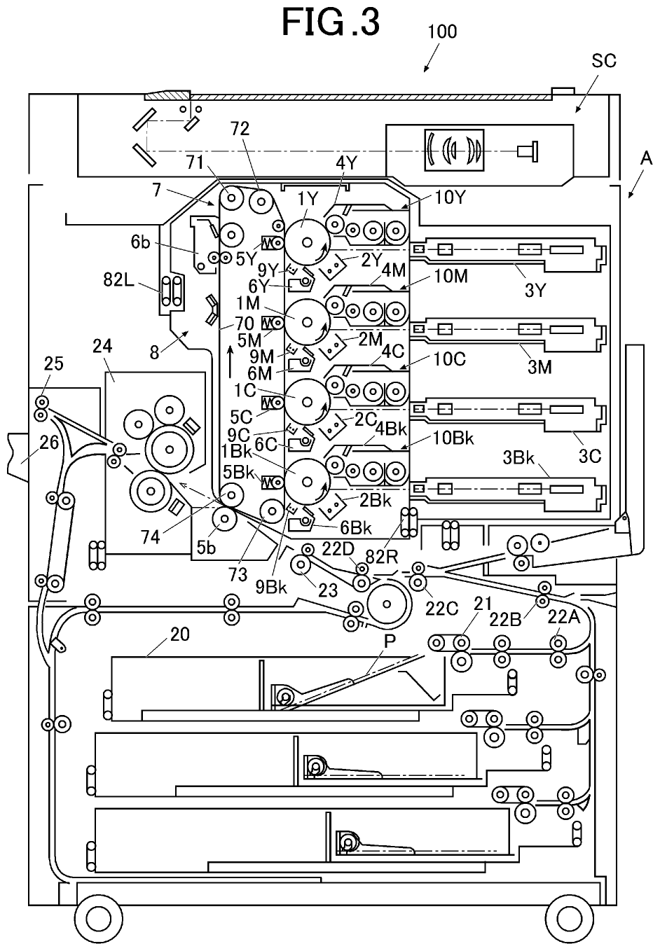

In the image forming method, for example, an image forming apparatus as illustrated in FIG. 3 can be used. FIG. 3 is a schematic cross-sectional view illustrating an example configuration of the image forming apparatus.

The image forming apparatus 100 is referred to as a tandem-type color image forming apparatus. The image forming apparatus 100 includes four sets of image forming sections (image forming units) 10Y, 10M, 10C, and 10Bk arranged in tandem in the vertical direction. The image forming apparatus 100 also includes an intermediate transferer unit 7, a sheet feeding means 21, and a fixing means 24. At an upper part of a main body A of the image forming apparatus 100, a document image scanning device SC is arranged.

The intermediate transferer unit 7 includes an endless belt-shaped intermediate transfer body 70 which is rotatable by being wound around rollers 71, 72, 73, and 74. Furthermore, the intermediate transferer unit 7 includes primary transfer rollers 5Y, 5M, 5C, and 5Bk, and a cleaning means 6b.

The four image forming units 10Y, 10M, 10C, and 10Bk have drum-shaped photoreceptors 1Y, 1M, 1C, and 1Bk, respectively, at their centers. The image forming units includes respective charging means 2Y, 2M, 2C and 2Bk, exposure means 3Y, 3M, 3C and 3Bk, rotating developing means 4Y, 4M, 4C and 4Bk, and cleaning means 6Y, 6M, 6C and 6 Bk for cleaning the photoreceptors bY, 1M, 1C and 1Bk, which are arranged around the respective photoreceptors.

The image forming units 10Y, 10M, 10C, and 10Bk form toner images in yellow, magenta, cyan, and black, respectively. The charging step, the exposure step, and the developing step are steps of forming a toner image on the photoreceptor. In the image forming apparatus 100, the image forming units 10Y, 10M, 10C, and 10Bk perform these steps using the above-described toners. Details thereof will be described below. The toner is preferably mixed with a carrier to be used as a two-component developer.

The image forming units 10Y, 10M, 10C, and 10Bk form toner images of different colors on the photoreceptors 1Y, 1M, 1C, and 1Bk, respectively. The configurations are the same except for the colors. The image forming unit 10Y will be described in detail as an example.

The image forming unit 10Y includes a charging means 1Y, an exposure means 2Y, a developing means 3Y, and a cleaning means 4Y, which are disposed around a photoreceptor 6Y that is an image forming body. The image forming unit 10Y forms a yellow (Y) toner image on the photoreceptor 1Y. Furthermore, in the present embodiment, at least the photoreceptor 10Y, the charging means 1Y, the developing means 2Y, and the cleaning means 4Y of the image forming unit 6Y are provided integrally.

The charging means 2Y is a unit that applies a uniform potential to the photoreceptor 1Y. The charging means may be of a contact or non-contact roller charging type, and is preferably of a contact roller charging type.

The exposure means 3Y is a means that performs exposure based on an image signal (yellow), on the photoreceptor 1Y to which a uniform potential has been applied by the charging means 2Y, so as to form an electrostatic charge image corresponding to a yellow image. Examples of the exposure means 3Y include one composed of LEDs and image forming elements in which light emitting elements are arranged in an array in the axial direction of the photoreceptor 1Y, and one using a laser optical system.

The developing means 4Y includes, for example, a developing sleeve which has a built-in magnet and rotates while holding the two-component developer, and a voltage applying device which applies a DC or AC bias voltage between the photoreceptor bY and the developing sleeve.

The cleaning means 6Y includes a cleaning blade that is disposed such that the tip is in contact with the surface of the photoreceptor bY. The image forming apparatus includes a brush roller which is provided in the upstream of the cleaning blade and is in contact with the surface of the photoreceptor bY.

The cleaning blade has the function of scraping the surface of the photoreceptor 1Y as well as the function of removing the residual toner attached on the photoreceptor 1Y.

The brush roller has functions of removing the residual toner attached on the photoreceptor 1Y, collecting the residual toner removed by the cleaning blade, and scraping the surface of the photoreceptor 1Y. That is, the brush roller comes into contact with the surface of the photoreceptor 1Y and rotates in the same direction as the photoreceptor 1Y at the contact portion. Next, the brush roller removes residual toner and paper dust on the photoreceptor 1Y, and conveys and collects the residual toner removed by the cleaning blade.

In the image forming apparatus 100, an intermediate transferer is used in the step of transferring a toner image formed on a photoreceptor to a transfer medium. After a toner image is primarily transferred onto an intermediate transferer, the transferred toner image is secondarily transferred onto a recording medium.

The toner images in the respective colors formed by the image forming units 10Y, 10M, 10C, and 10Bk are sequentially transferred, by primary transfer rollers 5Y, 5M, 5C, and 5Bk serving as primary transfer means, onto a rotating endless belt-shaped intermediate transferer 70 of an intermediate transferer unit 7. Then, a superimposed color image is formed.

The endless belt-shaped intermediate transfer member 70 is a semiconductive endless belt-shaped second image carrier wound around and rotatably supported by a plurality of rollers 71, 72, 73, and 74.

The color image superimposed on the endless belt-shaped intermediate transfer member 70 is then transferred to a recording medium P. As used herein, the recording medium is an image support that carries a fixed final image, and examples thereof include plain paper and a transparent sheet.

Specifically, the recording medium P accommodated in the sheet feed cassette 20 is fed by the sheet feeding means 21. The recording medium P is conveyed to a secondary transfer roller 5b as a secondary transfer means via a plurality of intermediate rollers 22A, 22B, 22C, and 22D, and registration rollers 23.

Then, the color images are collectively transferred (secondarily transferred) from the endless belt-shaped intermediate transferer 70 onto the recording medium P by the secondary transfer roller 5b. The recording medium P onto which the color images have been transferred is subjected to fixing processing by the fixing means 24, pinched between the sheet ejection rollers 25, and placed on a sheet ejection tray 26 outside the apparatus.

The fixing means 24 is, for example, of a heat roller fixing type. The fixing roller of a heat roller fixing type is composed of a heating roller internally provided with a heat source and a pressure roller that is in pressure contact with the heating roller so as to form a fixing nip portion.

On the other hand, the color image is transferred onto a recording medium P by a secondary transfer roller 5b as a secondary transfer means. Thereafter, the endless belt-shaped intermediate transferer 70 from which the recording medium P has been self-stripped is subjected to removal of residual toner by the cleaning means 6b.

During the image formation processing, the primary transfer roller 5Bk is constantly in contact with the photoreceptor 1Bk. The other primary transfer rollers 5Y, 5M, and 5C contact the corresponding photoreceptors 1Y, 1M, and 1C, respectively, only when a color image is formed. The secondary transfer roller 5b comes into contact with the endless belt-shaped intermediate transfer member 70 only when the recording medium P passes therethrough and the secondary transfer is performed.

Further, in the image forming apparatus 100, a housing 8 constituted by the image forming sections 10Y, 10M, 10C and 10Bk and the intermediate transferer unit 7 can be pulled out from the apparatus main body A through supporting rails 82L and 82R.

Although a color laser printer has been described using the image forming apparatus 100 illustrated in FIG. 3, the image forming apparatus is similarly applicable to a monochrome laser printer or a copying machine. In addition, as the exposure light source, a light source other than a laser, for example, an LED light source may be used.

### Examples

Hereinafter, the present invention will be specifically described by way of examples, but the present invention is not limited thereto. In the examples, “part(s)” or “%” means “part(s) by mass” or “% by mass” unless otherwise specified.

In the following examples, operations were performed at room temperature (25° C.) unless otherwise specified.

### 1. Preparation of Electrostatic Charge Image Developing Toner

### (1) Preparation of Amorphous Polyester Dispersion

### (1.1) Synthesis of Amorphous Polyester 1 (AP-1)

Bisphenol A ethylene oxide adduct: 11.0 parts by mass
Bisphenol A propylene oxide adduct: 29.0 parts by mass
Ethylene glycol: 34.0 parts by mass
Propylene glycol: 41.0 parts by mass
Terephthalic acid: 100.0 parts by mass
Dodecenyl succinic acid: 130.0 parts by mass
Trimellitic acid: 15.0 parts by mass

The monomer components were charged into a reaction vessel equipped with a stirrer, a thermometer, a condenser, and a nitrogen gas inlet tube. Next, the atmosphere in the reaction vessel was replaced with dry nitrogen gas, and then 0.3% by mass of tin dioctanoate with respect to the total mass of the sum of the monomer components was charged into the reaction vessel. Under a nitrogen gas flow, the temperature was increased to 235° C. over 1 hour, and the monomers were reacted for 3 hours. The pressure in the reactor was reduced to 10.0 mmHg, the mixture was stirred and reacted, and the reaction was terminated when the reactant had a desired molecular weight.

The obtained amorphous polyester 1 had a glass transition temperature of 61° C. and a weight average molecular weight of 42,000.

### (12) Synthesis of Amorphous Polyesters 2 to 9 (AP-2 to AP-9)

Amorphous polyesters 2 to 9 (AP-2 to AP-9) were synthesized by the same procedure as in the synthesis of amorphous polyester 1 except that the polyhydric alcohol monomer component was changed as described in Table I.

Table I shows the polyhydric alcohol component used in the synthesis of each amorphous polyester. Note that “−” indicates that the corresponding component was not used.

TABLE I

| | AP1 | AP2 | AP3 | AP4 | AP5 | AP6 | AP7 | AP8 | AP9 |
|---|---|---|---|---|---|---|---|---|---|
| BISPHENOL A ETHYLENE | 11 | 6 | — | — | — | — | — | 57 | 114 |
| OXIDE ADDUCT | | | | | | | | | |
| (PARTS BY MASS) | | | | | | | | | |
| BISPHENOL A PROPYLENE | 29 | 14 | — | — | — | — | — | 145 | 290 |
| OXIDE ADDUCT | | | | | | | | | |
| (PARTS BY MASS) | | | | | | | | | |
| ETHYLENE GLYCOL | 34 | 35 | 37 | 37 | 37 | 37 | 37 | 19 | — |
| (PARTS BY MASS) | | | | | | | | | |
| PROPYLENE GLYCOL | 41 | 43 | 46 | — | — | — | — | 23 | — |
| (PARTS BY MASS) | | | | | | | | | |
| PENTANEDIOL | — | — | — | 63 | — | — | — | — | — |
| (PARTS BY MASS) | | | | | | | | | |
| NEOPENTYL GLYCOL | — | — | — | — | 63 | — | — | — | — |
| (PARTS BY MASS) | | | | | | | | | |
| HEXANEDIOL | — | — | — | — | — | 71 | — | — | — |
| (PARTS BY MASS) | | | | | | | | | |
| HEPTANEDIOL | — | — | — | — | — | — | 79 | — | — |
| (PARTS BY MASS) | | | | | | | | | |

### (13) Preparation of Amorphous Polyester Dispersion 1 (AP-1)

Amorphous polyester 1 (AP-1): 100.0 parts by mass
Methyl ethyl ketone: 60.0 parts by mass
Isopropyl alcohol: 15.0 parts by mass

The above components were charged into a reaction vessel equipped with a stiffer and dissolved at 60° C.
10% aqueous ammonia solution: 3.5 parts by mass

Then, the reaction vessel was cooled to 35° C., and then the above components were added thereto.
Ion exchange water: 300.0 parts by mass

Then, the above components were added dropwise to the reaction vessel over 3 hours. Next, methyl ethyl ketone and isopropyl alcohol were removed using an evaporator to obtain an amorphous polyester dispersion 1 (AP-1). The median size of the particles of the obtained amorphous polyester was 150 nm.

### (1.4) Preparation of Amorphous Polyester Dispersion 2 to 9 (AP-2 to AP-9)

Amorphous polyester dispersions 2 to 9 were obtained in the same procedure as in the preparation of the amorphous polyester dispersion 1 except that the amorphous polyester 1 was changed to the amorphous polyesters 2 to 9.

### (2) Preparation of Crystalline Polyester Dispersion

### (2.1) Synthesis of Crystalline Polyester 1 (CP-1)

1,10-decanedicarboxylic acid: 350.0 parts by mass
1,6-Hexanediol: 170.0 parts by mass

The monomer components were charged into a reaction vessel equipped with a stiffer, a thermometer, a condenser, and a nitrogen gas inlet tube. Next, the atmosphere in the reaction vessel was replaced with dry nitrogen gas, and then 0.3% by mass of tin dioctanoate with respect to the total mass of the sum of the monomer components was charged into the reaction vessel. Under a nitrogen gas flow, the mixture was stirred and reacted at 160° C. for 3 hours, and then the temperature was further increased to 180° C. over 1.5 hours. The pressure in the reactor was reduced to 3 kPa, and the reaction was terminated when a desired molecular weight was obtained. The crystalline polyester1 (CP-1) was thus obtained. The obtained crystalline polyester 1 (CP-1) had a melting point of 73° C. and a weight average molecular weight of 28,000.

### (22) Preparation of Crystalline Polyester Dispersion 1 (CP-1)

Crystalline polyester 1 (CP-1): 100.0 parts by mass
Methyl ethyl ketone: 60.0 parts by mass
Isopropyl alcohol: 15.0 parts by mass

The above components were charged into a reaction vessel equipped with a stirrer and dissolved at 65° C.
10% aqueous ammonia solution: 5.0 parts by mass

Then, after the reaction vessel was cooled to 60° C., the above components were added thereto.
Ion exchange water: 300.0 parts by mass

Then, the above components were added dropwise to the reaction vessel over 3 hours. Next, methyl ethyl ketone and isopropyl alcohol were removed using an evaporator to obtain a crystalline polyester dispersion 1 (CP-1). The median size of the particles of the obtained crystalline polyester was 150 nm.

### (3) Preparation of Release Agent Dispersion

Paraffin wax “HNP-9” (manufactured by Nippon Seiro Co., Ltd): 100.0 parts by mass
Anionic surfactant “NEOGEN (R) RK” (manufactured by Dai-ichi Kogyo Seiyaku Co., Ltd): 1.0 parts by mass
Ion exchange water: 350.0 parts by mass

The above components were mixed, heated to 100° C., and dispersed using a homogeniser “Ultra-Turrax T50” (manufactured by Ika-Werke GmbH & Co. KG). Thereafter, the mixture was subjected to dispersion treatment with a Manton-Gaulin high-pressure homogenizer (manufactured by Gaulin Corp.) to obtain a release agent dispersion. The median diameter of the particles of the obtained release agent was 200 nm.

### (4) Preparation of Cyan Colorant Dispersion

Cyan pigments (manufactured by Dainichiseika Color & Chemicals Mfg. Co., Ltd., Pigment Blue 15:3 (copper phthalocyanine)): 45.0 parts by mass
Anionic surfactant “NEOGEN (R) R” (manufactured by Dai-ichi Kogyo Seiyaku Co., Ltd): 2.0 parts by mass
Ion exchange water: 250.0 parts by mass

The above components were mixed and dispersed using a high-pressure impact disperser Ultimizer “HJP30006” (manufactured by Sugino Machine Co., Ltd.) to obtain a cyan colorant dispersion. The median size of the particles of the obtained colorant was 150 nm.

### (5) Preparation of Toner

### (5.1) Preparation of Toner 1

Amorphous polyester dispersion 1 (AP-1) (solid content): 54.5 parts by mass
Crystalline Polyester Dispersion 1 (CP-1) (solid content): 15.0 parts by mass
Release agent dispersion (solid content): 4.5 parts by mass
Cyan colorant dispersion (solid content): 6.0 parts by mass
10% aqueous solution of aluminum sulfate: 6.3 parts by mass
Ion exchange water: 650.0 parts by mass

A round stainless steel flask was charged with the above components. Next, the mixture was mixed and dispersed using a homogeniser “Ultra-Turrax T50” (manufactured by IKA Corp.) at 5000 rpm for 10 minutes. Thereafter, the reaction product in the flask was heated to 40° C. with stirring. Thereafter, the temperature was raised at 0.5° C. per minute, and when the particle size of the reactant became 5.5 μm, the temperature was maintained.
Amorphous polyester dispersion 1 (AP-1) (solid content): 20.0 parts by mass

Next, the above components were added dropwise over 1 hour.
Ethylenediaminetetraacetic acid (EDTA) tetrasodium salt “Chelest 40” (manufactured by Chelest Corporation): 11.0 parts by mass

After the addition of the above components, an aqueous sodium hydroxide solution was added to adjust the pH of the reaction liquid to 8. Then, after the temperature of the reaction solution was raised to 82.5° C., the pH of the reaction solution was decremented by 0.05 with nitric acid every 10 minutes, and stirring was continued for 45 minutes.

The reaction liquid was cooled until the temperature thereof became 40° C. or less, the stirring was stopped, and then an aggregate was filtered and removed with a filter having an aperture size of 45 μm. Then, the pH of the reaction liquid was adjusted to 4 with hydrochloric acid, and thereafter a water-containing cake (aggregate of toner base particles) was taken out using a centrifugal separator. The water-containing cake was washed with ion-exchanged water in an amount of 10 times the solid content of the toner base particles while being centrifuged, and then dehydrated for 10 minutes to obtain a water-containing cake of toner base particles 1.

Subsequently, a drying treatment was performed using “Flash Jet Dryer” (manufactured by Seishin Co., Ltd). The airflow temperature and the airflow velocity measured and calculated by the above-described methods were set to 80° C. and 10 m/sec, respectively. The obtained hydrous cake 1 was supplied to the dryer so that the outlet temperature of the dryer became 35° C. The drying treatment was thus performed. The amount of moisture in the aggregate of the toner base particles after the drying treatment was measured and found to be 1.2% by mass with respect to the total mass of the toner base particles.
Toner base particle 1:100.0 parts by mass
Hydrophobic silica particles (number-average primary particle size: 12 nm, degree of hydrophobicity: 68): 1.0 parts by mass
Hydrophobic titanium dioxide particles (number-average primary particle size: 20 nm, degree of hydrophobicity: 63): 0.5 parts by mass
Sol-gel silica (number-average primary particle size: 110 nm): 1.0 parts by mass

The above components were mixed in a Henschel mixer (manufactured by Nippon Coke & Engineering Co., Ltd) at a rotor peripheral speed of 40 m/sec and 32° C. for 20 minutes. After the mixing, coarse particles were removed with a sieve having an aperture size of 45 μm to obtain toner 1.

### (52) Production of Toners 2 to 21

In the production of toner 1, the amorphous polyester, the dehydration time in the washing step, and the airflow temperature and airflow velocity in the drying step were changed as listed in Table II. Toners 2 to 21 were produced in the same manner as in the production of the toner 1 except for the above.

The airflow temperature and the airflow velocity were measured and calculated by the above-described methods.

### 2. Preparation of Two-Component Developer

Toner: 6.0 parts by mass
Ferrite carrier (volume average particle diameter of 60 μm): 100.0 parts by mass

The above components were mixed to produce two-component developers 1 to 21.

### 3. Evaluation

### (1) Low-Temperature Fixability

The fixing device used was the multifunction peripheral “bizhub PRESS (R) C1070” (manufactured by Konica Minolta, Inc.) that was modified so that the surface temperatures of the upper fixing belt and the lower fixing roller can be changed. Next, the obtained two-component developers were loaded into the multifunction peripheral. The multifunction peripheral was modified so that the fixing temperature, the toner adhesion amount, and the system speed were changeable.

The amount of toner adhered to A4 size high-quality paper “NPI High—Quality (127.9 g/m²)” (manufactured by Nippon Paper Industries Co., Ltd) under an environment of ordinary temperature and ordinary moisture (a temperature of 20° C. and a relative humidity of 50%) was set to 11.3 g/m². Then, an experiment of fixing an image having a 100 mm×100 mm size was performed.

The experiment of fixing an image was repeatedly performed while increasing the fixing temperature from 110° C. in increments of 2° C. until the fixing temperature reached 180° C. The lowest fixing temperature at which image contamination due to fixing offset was not visually observed was defined as the lowest fixing temperature (U.O. avoidance temperature). Next, the low-temperature fixability was evaluated according to the following evaluation criteria. The results are shown in Table II below.

### (Evaluation Criterion)

A: The lowest fixing temperature is lower than 135° C. (excellent toner having excellent low-temperature fixability).
B: The minimum fixing temperature is 135° C. or more and less than 140° C. (no problem for practical use).
C: The lowest fixing temperature is 140° C. or higher fixing is not sufficient at a target sheet passing speed and problematic for practical use).

### (2) Image Unevenness

Each of the obtained two-component developers was loaded into a developing device of developing means of a commercially available full color copier “bizhub PRESS (R) C1060” (Konica Minolta, Inc.) to perform the following evaluation.

A solid patch image having a toner adhesion amount of 4 g/m² and 20 mm×20 mm size was output on “POD gloss coated paper 128 g/m²” (manufactured by Oji Paper Co., Ltd.) under an environment of a temperature of 30° C. and a relative humidity of 85% (high-temperature high-humidity environment). The density of a 20 mm square image of this printed material was then measured at five points with a fluorescence spectrodensitometer FD-7 (Konica Minolta, Inc.) to determine the difference in reflection density (difference between maximum and minimum values) of the solid image and evaluated according to the following criteria. In this evaluation, a sample having a reflection density difference of 0.10 or less is evaluated as acceptable.

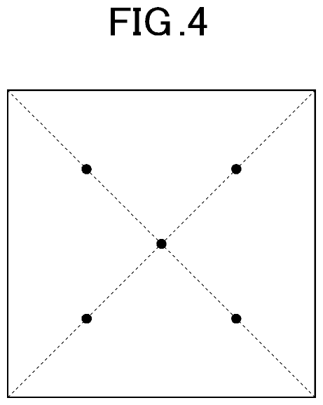

As the five points in the image, as shown in FIG. 4, the intersection of the diagonal lines was set as the center point, and the center point and the middle points between the center point and the four corners, that is, a total of five points were selected.

### (Evaluation Criterion)

A: The reflection density difference is 0.05 or less, and there is no problem in practical use.
B: The reflection density difference is more than 0.05 and 0.10 or less, and there is no problem in practical use.
C: The difference in reflection density exceeds 0.10, which is problematic in practical use.

The evaluation results are shown in Table II.

Note that “Content*1” in the table represents the content of the structural unit derived from bisphenol A or a bisphenol A derivative with respect to the total moles of the structural units derived from polyhydric alcohols in the amorphous polyesters AP-1 to AP-9. The content was measured by the above-described pyrolysis gas chromatography mass spectrometry (GC/MS).

TABLE II

| | | | | WASHING | DRYING STEP | | | | |
|---|---|---|---|---|---|---|---|---|---|
| | | | | STEP | BLOW | | IMAGE UNEVENNESS | | LOW-TEMPER- |
| | | NON-CRYS- | | DEHYDRATION | TEMPER- | BLOW | REFLECTION | | ATURE |
| | TONER | TALLINE | CONTENT | TIME | ATURE | SPEED | DENSITY | EVALU- | FIXABILITY |
| | NO. | POLYESTER | *1 | (min) | (° C.) | (m/sec) | DIFFERENCE | ATION | EVALUATION |
| EXAMPLE 1 | 1 | AP1 | 10 | 10 | 80 | 10 | 0.10 | B | B |
| EXAMPLE 2 | 2 | AP2 | 5 | 10 | 80 | 10 | 0.09 | B | B |
| EXAMPLE 3 | 3 | AP3 | 0 | 10 | 80 | 10 | 0.08 | B | B |
| EXAMPLE 4 | 4 | AP4 | 0 | 10 | 80 | 10 | 0.04 | A | B |
| EXAMPLE 5 | 5 | AP5 | 0 | 10 | 80 | 10 | 0.03 | A | B |
| EXAMPLE 6 | 6 | AP6 | 0 | 10 | 80 | 10 | 0.04 | A | B |
| EXAMPLE 7 | 7 | AP7 | 0 | 10 | 80 | 10 | 0.04 | A | B |
| EXAMPLE 8 | 8 | AP5 | 0 | 10 | 70 | 10 | 0.05 | A | B |
| EXAMPLE 9 | 9 | AP5 | 0 | 10 | 60 | 10 | 0.07 | B | B |
| EXAMPLE 10 | 10 | AP5 | 0 | 10 | 80 | 20 | 0.04 | A | B |
| EXAMPLE 11 | 11 | AP5 | 0 | 10 | 80 | 30 | 0.08 | B | B |
| EXAMPLE 12 | 12 | AP5 | 0 | 10 | 80 | 35 | 0.08 | B | B |
| EXAMPLE 13 | 13 | AP5 | 0 | 10 | 80 | 8 | 0.04 | A | B |
| EXAMPLE 14 | 14 | AP5 | 0 | 5 | 80 | 10 | 0.04 | A | B |
| EXAMPLE 15 | 15 | AP5 | 0 | 15 | 80 | 10 | 0.04 | A | B |
| EXAMPLE 16 | 16 | AP5 | 0 | 20 | 80 | 10 | 0.08 | B | B |
| EXAMPLE 17 | 17 | AP5 | 0 | 10 | 80 | 5 | 0.07 | B | B |
| COMPARISON | 18 | AP8 | 50 | 10 | 80 | 10 | 0.18 | C | C |
| 1 | | | | | | | | | |
| COMPARISON | 19 | AP9 | 100 | 10 | 80 | 10 | 0.20 | C | C |
| 2 | | | | | | | | | |
| COMPARISON | 20 | AP5 | 0 | 10 | 50 | 10 | 0.22 | C | B |
| 3 | | | | | | | | | |
| COMPARISON | 21 | AP5 | 0 | 10 | 80 | 3 | 0.15 | C | B |
| 4 | | | | | | | | | |

It is understood from examples and comparisons that an image formed by using the toner produced by the method of the present invention has suppressed unevenness in density.

A comparison of Examples 1 to 3 shows that the reflection density difference in image unevenness is decreased because the amorphous polyester does not have a structural unit derived from bisphenol A or a bisphenol A derivative as a structural unit derived from a polyhydric alcohol.

Comparison of Examples 1, 10 to 13, and 17 shows that when the velocity of the airflow is within a range of 8 to 20 m/sec, image unevenness can be further suppressed.

Although several embodiments of the present invention have been described, the scope of the present invention is not limited to the above-described embodiments, but encompasses the scope of the invention described in the claims and equivalents thereof.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-060792 filed on Apr. 4, 2023 is incorporated herein by reference in its entirety.

What is claimed is:

1. A method for producing an electrostatic charge image developing toner, comprising: drying wet toner base particles to produce the electrostatic charge image developing toner, wherein
the toner base particles contain an amorphous polyester that is a polycondensate of a polyvalent carboxylic acid and a polyhydric alcohol,
in the amorphous polyester, a content of a structural unit derived from bisphenol A or a bisphenol A derivative is 10 mol % or less with respect to total moles of a structural unit derived from the polyhydric alcohol,
the drying comprises drying the wet toner base particles with an airflow in a dryer,
a temperature of the airflow is equal to or higher than 60° C., and
a velocity of the airflow is greater than or equal to 5 m/sec.

2. The method for producing an electrostatic charge image developing toner according to claim 1, wherein
the amorphous polyester does not have the structural unit derived from bisphenol A or a bisphenol A derivative as the structural unit derived from the polyhydric alcohol.

3. The method for producing an electrostatic charge image developing toner according to claim 1, wherein
the polyhydric alcohol is an aliphatic polyhydric alcohol having 5 to 7 carbon atoms.

4. The method for producing an electrostatic charge image developing toner according to claim 1, wherein
a content of the amorphous polyester is equal to or greater than 20% by mass with respect to a total mass of the toner base particles.

5. The method for producing an electrostatic charge image developing toner according to claim 1, wherein
a glass transition temperature of the amorphous polyester is in a range of 30 to 70° C.

6. The method for producing an electrostatic charge image developing toner according to claim 1, wherein
a glass transition temperature of the electrostatic charge image developing toner is in a range of 15 to 40° C.

7. The method for producing an electrostatic charge image developing toner according to claim 1, wherein
the toner base particles contain a crystalline polyester.

8. The method for producing an electrostatic charge image developing toner according to claim 7, wherein
a melting point of the crystalline polyester is equal to or less than 75° C.

9. The method for producing an electrostatic charge image developing toner according to claim 7, wherein
the crystalline polyester has a structural unit derived from an aliphatic diol and a structural unit derived from an aliphatic carboxylic acid.

10. The method for producing an electrostatic charge image developing toner according to claim 9, wherein
the aliphatic diol or the aliphatic carboxylic acid has 6 to 10 carbon atoms.

11. The method for producing an electrostatic charge image developing toner according to claim 1, wherein
the toner base particles contain a release agent, and
a melting point of the release agent is in a range of 60 to 80° C.

12. The method for producing an electrostatic charge image developing toner according to claim 1, wherein
the toner base particles have a core-shell structure.

13. The method for producing an electrostatic charge image developing toner according to claim 1, wherein
the velocity of the airflow is in a range of 8 to 20 m/sec.

14. The method for producing an electrostatic charge image developing toner according to claim 1, wherein
a content of a solvent in the wet toner base particles is in a range of 15 to 30 mass %.

15. The method for producing an electrostatic charge image developing toner according to claim 1, wherein
the method further comprises desolvating the wet toner base particles before the drying.
